(19) United States
(12) Patent Application Publication
(10) Pub. No.: US 2013/0159408 A1
(43) Pub. Date: Jun. 20, 2013

(54) ACTION-ORIENTED USER EXPERIENCE BASED ON PREDICTION OF USER RESPONSE ACTIONS TO RECEIVED DATA

(71) Applicants: John Winn, Cambridge (GB); Fernando Garcia, Seattle, WA (US); Tore Sundelin, Duvall, WA (US); James Edelen, Renton, WA (US)

(72) Inventors: John Winn, Cambridge (GB); Fernando Garcia, Seattle, WA (US); Tore Sundelin, Duvall, WA (US); James Edelen, Renton, WA (US)

(73) Assignee: MICROSOFT CORPORATION, Redmond, WA (US)

(21) Appl. No.: 13/360,594

(22) Filed: Jan. 27, 2012

Related U.S. Application Data
(63) Continuation-in-part of application No. 13/326,877, filed on Dec. 15, 2011.

(51) Int. Cl. G06F 15/16

(52) U.S. Cl. 709/204

(57) ABSTRACT

A system is provided for automatically notifying a user of predicted action. The system may be configured to monitor and observe a user's interactions with incoming data, identify patterns of actions the user may take in response to the incoming data and generate a notification associated with the action. A trainer component and a classifier component determine the probability a user may take a particular action and to make predictions of likely user actions based on the observations of the user. A notifier may communicate with the classifier to generate a particular user notification associated with a user action response generated by the classifier. The notifier component utilizes a logic device to compare the received user prediction from the classifier with a plurality of user notifications stored in a database. The notifier component sends the user notification to one or more user devices associated with a user.

### RELATED APPLICATION

This is a continuation-in-part of co-pending U.S. non-provisional patent application Ser. No. 13/326,877, filed Dec. 15, 2011, the entirety of which application is incorporated by reference herein.

### BACKGROUND

In a cloud-based or local device environment, users may receive vast amounts of data from a number of data sources such as content generators, databases, search engines, other users, and so on. For example, users may receive phone calls, email messages, calendar requests, text messages and other types of data and alerts. Manually reading, responding, and organizing these vast amounts of data can be overwhelming, time-consuming, and inefficient for the individual users.

Some applications attempt to simplify user actions in response to the data by anticipating the actions the user may take upon receipt of the incoming data. Such applications may attempt to understand the behaviors of the user by classifying the user's behavior based on observed user response trends. However, these attempts have limitations as the observed trends are too simplistic, generic, broad, or vague to accurately predict how the user may respond to the incoming data. In addition, prior attempts have not provided adequate notification to the user of the predicted response or are limited to a user's device that received the incoming data. In particular, prior attempts at anticipating a user's actions are localized to the user's device upon which the incoming data was received rather than providing cross modal notification to a plurality of client devices associated with the user. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to a system for providing a user notification of a predicted action response. The predicted action response is a result of monitoring a user's interactions with incoming data and to identify patterns of actions the user may take in response to the incoming data. The system may enable a trainer component and a classifier component to determine the probability a user may take a particular action and to make predictions of likely user responses based on the observations of the user and the identified pattern of the user's actions. The system receives the predicted action response and assigns a user notification thereto. The user notification is assigned to the predicted action response based on a list of user notifications stored in a user notification database. The user notification is sent to the user and may be displayed by an output device.

In one embodiment, for example, an apparatus may comprise a logic device and a notifier component operative on the logic device. The logic device may comprise, for example, a processor that accesses a memory having a plurality of user notifications stored thereon. The notifier component is operative to receive a predicted action response associated with incoming data. The predicted action response is based on a pattern of user actions associated with received incoming data. The notifier component determines whether a user notification corresponds to the predicted action response by comparing the predicted action response to a list of corresponding user notifications stored in memory. The notifier component sends the user notification to a client device where the user notification may be displayed to the user in one or more of a plurality of forms.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example cloud-based system for observing and predicting user actions, according to embodiments;

FIG. 2 illustrates a system for dynamically tracking user interactions with incoming data and predicting user response actions, according to embodiments;

FIG. 3 illustrates an example functional block diagram of dynamically tracking user interactions with incoming data and predicting user response actions, according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of tracking and predicting user actions in response to receipt of incoming data, according to embodiments.

FIG. 7 is a block diagram of a system for providing a user experience based on user response actions to received electronic data.

FIG. 8 is a block diagram of the components within the system of FIG. 7.

FIG. 9 is a functional block diagram illustrating the processing of a predicted user response action.

FIG. 10 is an exemplary user interface illustrating a user notification.

FIG. 11 is an exemplary user interface illustrating a user notification.

FIG. 12 illustrates one embodiment of a logic flow for the system of FIG. 7.

FIG. 13 illustrates one embodiment of a logic flow for the system of FIG. 7.

### DETAILED DESCRIPTION

As briefly described above, a system is provided for automatically predicting the actions a user is likely to take in response to receipt of incoming data. The system may include a feature extractor for gathering user data and extracting features to facilitate pattern recognition, one or more sensors for tracking user actions and reporting them to the system, and an actions processor for gathering the data from the sensors and digesting for the system to use. A classification model may be used to make predictions based on past observations and the data currently available. A training model may be used to synthesize the learnings from observing past data and the behaviors taken on it. Furthermore, an accuracy calculator may be used to measure the performance of the system and adjust the user experience accordingly. A notifier component may be included with the system and may communicate with the classifier to generate a particular user notification associated with a user action response generated by the classifier. The notifier component utilizes a logic device to compare the received user prediction from the classifier with a plurality of user notifications stored in a database. The notifier component sends the user notification to one or more user devices associated with a user.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for predicting user action in response to received incoming data. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

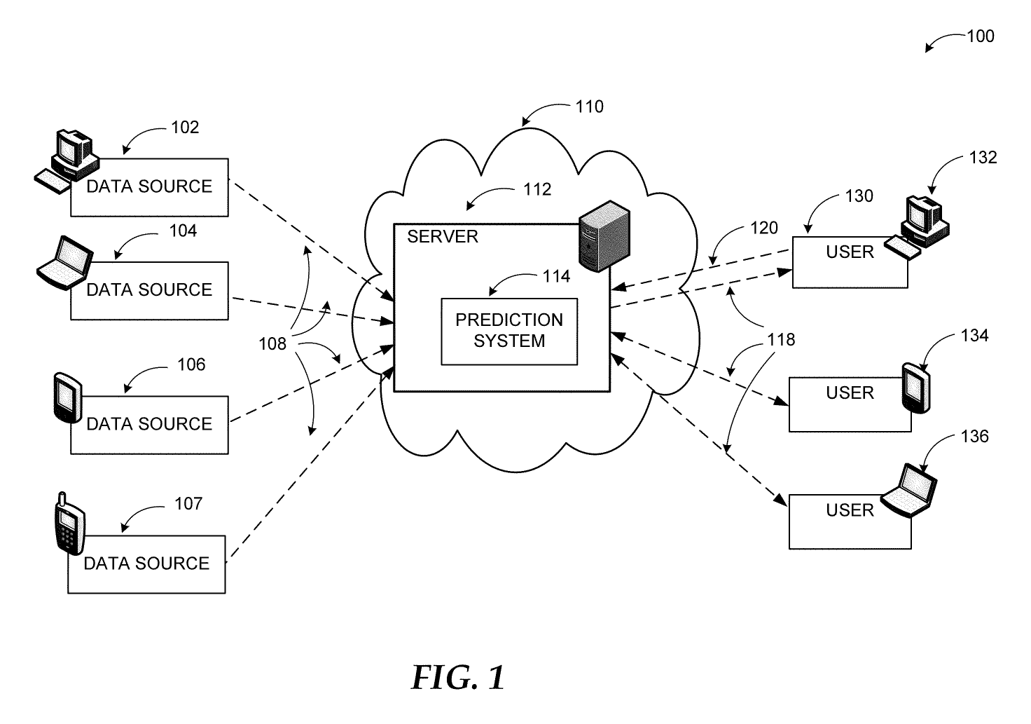

FIG. 1 illustrates an example cloud-based system for observing and predicting user actions, according to embodiments. As demonstrated in diagram 100, a server 112 within a cloud-based network 110 may include a prediction system 114 for observing user interactions with incoming data and predicting user actions in response to the incoming data. The server 112 within the cloud-based network 110 may facilitate receiving incoming data from a multitude of data sources 102, 104, 106 and delivering the data to one or more users 130.

In an example scenario in the cloud-based network 110, the user 130 may receive different types of data from multiple data sources 102, 104, 106 including email messages, text messages, instant messages, voicemail messages, phone calls, multimedia and/or audiovisual messages, documents, RSS feeds, social network updates, and other similar alerts and data. The user 130 may communicate with the server 112 over the cloud-based network 110 and may receive the incoming data over the cloud-based network 110 via a plurality of individual computing devices such as, for example, a laptop computer 136, a desktop computer 132, a smart phone 134, a car phone, a mobile phone, a tablet, and/or a home automation device.

In an example embodiment, upon receipt of incoming data over the cloud-based network 110 at the user's individual computing device, the user 130 may respond to the incoming data by executing a particular action. For example, in response to receipt of an email message, the user 130 may read and respond to the email, ignore, prioritize the email, delete the email, flag the email, move the email to a particular categorized folder, and/or save the email for later, as some example response actions. As another example, if the user 130 receives a calendar alert and/or an event request, the user may add the event to the user's personal calendar, and also may categorize the event as a work or personal event, and may mark the event as important. As yet another example, when the user receives a text message, some available response actions the user may take may include reading, responding, deleting, or saving the message for later. The above example response actions represent some available actions the user may take in response to incoming data, however, it is recognized that there are multiple other actions that may be available for a user to take in response to receipt of varying incoming data. In a further example, the user may read, edit, delete, or forward a received document depending on which computing device the document was received on or which application was used to receive the document. Thus, the context and the content of the document may impact how the user responds to it.

As mentioned above, the response actions the user 130 takes may depend on the context and subject of the incoming data, the location of the user 130, the device on which user 130 receives the data, and the time and date when the user 130 receives the incoming data. For example, the user 130 may respond to particular incoming data during business hours and other types of incoming data during evening or off hours. As an example of location based response actions, the user 130 may respond to work related data while the user 130 is located at work, and may save the same data for reviewing later if the user 130 is at home or on vacation. Further, if the user 130 is driving in the car, the user 130 may not read or respond to the incoming data while in the car, and upon arriving at a destination, the user 130 may read and execute a response action.

A system according to embodiments may enable analysis of the user's history of interactions with incoming data in order to predict the actions the user 130 is likely to take in response to receipt of current incoming data. The prediction system 114 may be configured to observe the user 130 as the user receives (118) the incoming data from one or more of the data sources 102, 104, 106 to identify what data the user 130 receives, and to identify what actions the user 130 takes upon receipt of the data. The prediction system 114 may continuously track the user over a period of time and identify a pattern of user behavior and response to received incoming data. Based on the tracked pattern of user response to the incoming data, the prediction system 114 may be able to determine a probability of the user 130 taking certain actions in response to certain incoming data. Based on the determined probabilities, the prediction system 114 may predict what action the user 130 may take upon receipt of particular data.

The prediction system 114 may be configured to predict a series of actions, when the actions are done, as well as context-based actions. For example, the prediction system 114 may recognize that in response to a particular incoming data, such as an email message, the user may read the message within an hour of receipt of the message and then reply to it. Additionally, the prediction system 114 may recognize the context and content of incoming data in order to predict user actions, such that upon receipt of an email message relating to the user's taxes or received from the user's accountant, the prediction system 114 may predict that the user 130 may save the email message to a “Tax Returns” folder stored on the user's personal computing device, for example. The prediction system 114 may also recognize that the user may print an attachment to an incoming message and/or may save an attachment to a designated folder on the user's computing device.

Based on the predicted actions, the prediction system 114 may be configured to suggest the predicted action to the user 130 and await user approval of the predicted action. In another embodiment, the prediction system 114 may automatically perform the predicted action on behalf of the user 130. For example, the system may automatically save an email attachment to a labeled folder or mark an incoming message as high priority for response. The prediction system 114 may further be configured to continuously observe the user actions in response to incoming data in order to continuously and dynamically update the determined probabilities and refine user action predictions in order to increase the accuracy of the predicted actions. Moreover, the prediction system 114 may be configured to monitor individual users, such that the prediction system 114 may make predictions of user action that are personalized to the specific observed user. The prediction system 114 may also be configured to monitor groups of users, such that a particular user's response action may be predicted based on group data observed and organized by the prediction system 114. For example, this may be done when a new user is enrolled in the system, to make useful predictions when no information about that specific user is available.

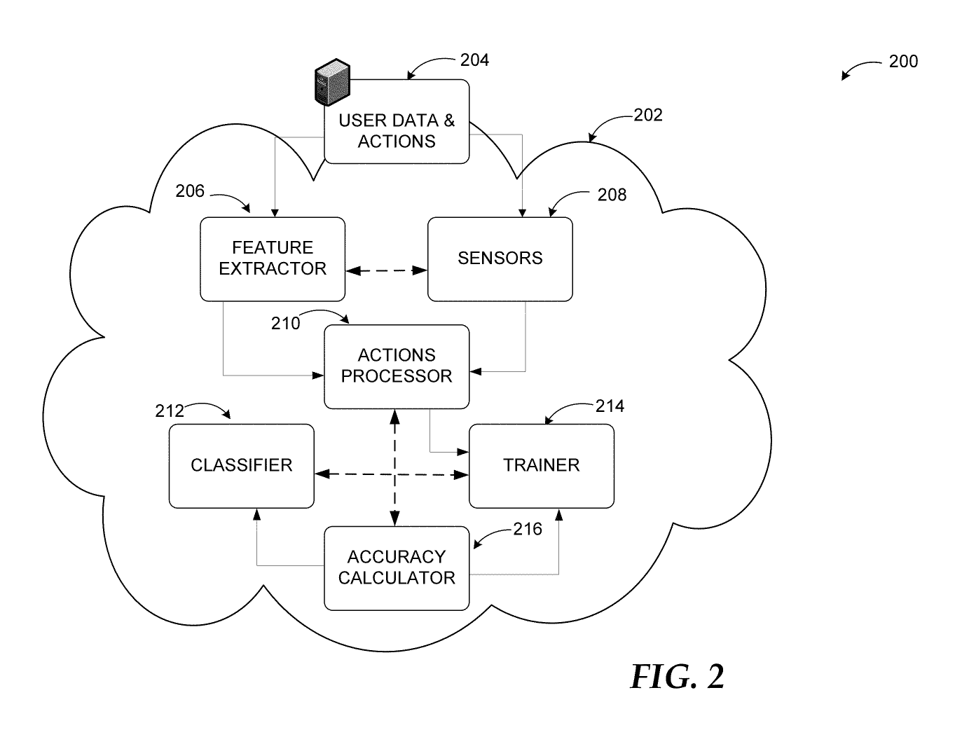

FIG. 2 illustrates a system for dynamically tracking user interactions with incoming data and predicting user response actions, according to embodiments. As discussed above in conjunction with FIG. 1, a system according to embodiments may enable the analysis of a user's interactions with incoming data in order to predict the actions the user is likely to take upon receipt of and in response to the data. As demonstrated in diagram 200, a prediction system 202, which may be a cloud-based, private or public networked, or locally installed system, and may be configured to observe a user's data and actions 204 as the user receives incoming data from one or more the data sources, identify what data the user receives, and identify what response actions the user takes upon receipt of the data. Based upon the observations, the prediction system 202 may predict likely user actions in response to current incoming data.

According to some embodiments, the prediction system 202 may employ a plurality of components in order to track the user's interactions and to make predictions of the user's likely response actions upon receipt of incoming data. As the user initially receives incoming data, a feature extractor 206 may monitor the incoming data and process the data in order to extract information about the incoming data, as well as other contextual data relevant to the incoming data such as other messages previously received in the same conversation, from the same sender. For example, the incoming data may contain a variety of information or features, such as, subject of the data, recipient name and/or list, urgency, date and time information, location of the user when the data is received, language-based content such as certain keywords or topics, and number of times the user has replied to the received message, to name a few. The feature extractor 206 may also identify the type of incoming data and the source of the data. The feature extractor 206 may analyze the incoming data and extract the features from the incoming data in order to facilitate generating a pattern of actions the user takes in response to incoming data containing various features.

The prediction system 202 may also employ one or more sensor 208 components for tracking user actions. During the user's interaction with the system 202, the sensor 208 component may be configured to continuously track the user's actions in response to incoming data. The sensor 208 may report the detected actions by the user to the prediction system 202, and the prediction system may upload and store the detected actions in order to facilitate identifying a pattern of user actions. The prediction system 202 may combine and store the data gathered from the feature extractor 206 and the sensor 208 for identifying a pattern of actions the user takes in response to the incoming data containing particular features.

In an example embodiment, the prediction system 202 may employ an actions processor 210 for facilitating combining, storing and organizing the data gathered from the sensor 208 and the feature extractor 206 to determine a pattern of user actions in response to receiving data containing particular features. The actions processor 210 may gather the data collected by the sensor 208, and using the data collected by the sensor 208 in conjunction with the data collected by the feature extractor 206, the actions processor 210 may be configured to produce a user behavior database, which may include a list of actions the user has taken in response to incoming data containing particular features. For example, the database may contain all of the actions the user has taken during past observations when the data contained specific features, such as the content of the data, the time the data was sent, who sent the data, and the location of the user when receiving the data. The database may categorize the data by individual features, and also by user actions taken in response, such that that the database may contain a detailed and complete record of the user's past actions in response to each identified feature of the incoming data.

In a further embodiment, the actions processor 210 may provide the complete database of past user actions to a trainer 214 component which may analyze the findings of the actions processor 210 to determine a pattern of actions the user takes when the incoming data includes particular features. The trainer 214 may access the database from the actions processor 210 in order to synthesize the observed data, and to learn from the past user action in order to enable the prediction system 202 to make predictions about user response actions in the future. During a training period, which may be specified by the prediction system 202, the trainer 214 may be configured to continuously gather the data and information collected and organized by the actions processor 210, and to analyze the data in order to identify the patterns and trends in the features of the data and the actions taken by the user. Based on the analysis of the data, the trainer 214 may generate conclusions, or learnings, which may indicate a probability of when certain user actions may be more or less likely to occur

Additionally, the trainer 214 may be configured to continuously train the prediction system, such that it may dynamically adjust the identified patterns of user behavior and increase its user action prediction accuracy. While incoming data is received by the user, the trainer may continuously gather the data and information collected and organized by the actions processor 210 to fine-tune the identified pattern of user response action. The trainer 214 may take into account the identified features of the incoming data and the user action executed in response to the data, in order to update the database in the actions processor 210. The trainer may produce a new set of data regarding user action in response to data with certain features, and also may augment and adjust pre-existing data in the database of past user actions to fine tune the database's accuracy. The updated database in the actions processor 210 may be used to make more accurate predictions of user action in response to future incoming data including in response to changes to the user's behavioral patterns themselves (e.g., as can occur when a user changes jobs, management, or responsibilities).

In a further embodiment, the prediction system may employ a classifier 212 for making predictions about the user's actions in response to current incoming data based on the pattern of user response action identified by the trainer 214. The classifier 212 may be configured to continuously interact with the trainer 214 in order to predict the user's response to current incoming data based on the pattern of user response action determined by the trainer 214 from the database of past user actions taken in response to data having certain features. In an example scenario, when new incoming data is received by the user, the classifier 212 may identify the current incoming data and identify the features present in the current incoming data. The classifier 212 may use the learnings and the pattern of user actions identified by the trainer 214 to predict the user's response according to the identified pattern. For example, the pattern determined from the database by the trainer 214 may indicate that the user performs a particular action a certain percent of the time when the incoming data includes a specific feature, such as time the data was sent, who sent the data, or where the user was located when the user receives the data.

Using the generated pattern of past user actions, the classifier 212 may determine a probability that the user may take a particular action in response to incoming data having a particular set of features. Based on the determined probability, the classifier 212 may predict the user's response to the current incoming data and may automatically execute the predicted action. In another embodiment, the classifier 212 may suggest the predicted action to the user, and upon approval by the user, the predicted action may be executed. Additionally, the classifier 212 may utilize a statistical model, for example, to determine the probabilities and make accurate predictions for the user's actions in response to current incoming data. The classifier 212 may include a pre-generated knowledge of statistically significant values for pre-determined variables, such as the user identity or the type of data, and may apply the appropriate statistical model for generating user action predictions.

In a further embodiment, the trainer 214 may interact with an accuracy calculator 216 in order to measure the performance of the prediction system 202 and to determine if the classifier 212 is making accurate predictions of user behavior. The trainer 214 may additionally monitor the classifier's 212 predictions of user actions, in order to determine if the predicted action coincides with the actual user action taken. The accuracy calculator 216 may be configured to compare predicted action data from the classifier 212 to observed user action data in the actions processor 210 and measure the accuracy of the predicted action. The accuracy data produced by the accuracy calculator 216 may be used by the trainer 214 to fine tune the database produced by the action processor 210 in order to generate more accurate predictions on future user actions. It may also be used to determine whether to inform the user of the predictions in a user interface.

As discussed above, various types of data such as email messages, text messages, forum posts, voicemail, phone calls, location information (e.g., GPS coordinates), images, etc. may be utilized. In case of collection of private user data such as user's locations, consent may be obtained from each user prior to collection and/or use of such data. A pre-generated global knowledge of a statistically significant number of sample users, or a seed model, may be employed to make accurate predictions for new users of a system. The system may also analyze any relevant, pre-existing data about “new” users in order to “retrospectively” begin to train a prediction model and thus more rapidly get to a point of being able to make accurate predictions about new, incoming data for the users. Examples of scenarios in which a user may be “new” but can have pre-existing, relevant data are when a user with existing data is newly migrated to the system or when a system that does not contain the invention is “upgraded” to one that does while still retaining some/all of the extant user data. In some embodiments, a client-server architecture may be used, where the client can store and process data offline to make predictions. In other embodiments, large quantities of data may be handled in a distributed fashion and processed for multiple users concurrently. A system according to embodiments may iterate on its learning phases (online/offline training). Implementations may be independent from any user experience designed to take advantage of the system such that enough data is provided so that the user interface can be tailored to the experience desired. A system according to some embodiments may have knowledge of when to look for new data for a single or multiple actions to increase its knowledge of a user and may be able to process the same data multiple times without adversely affecting its learning.

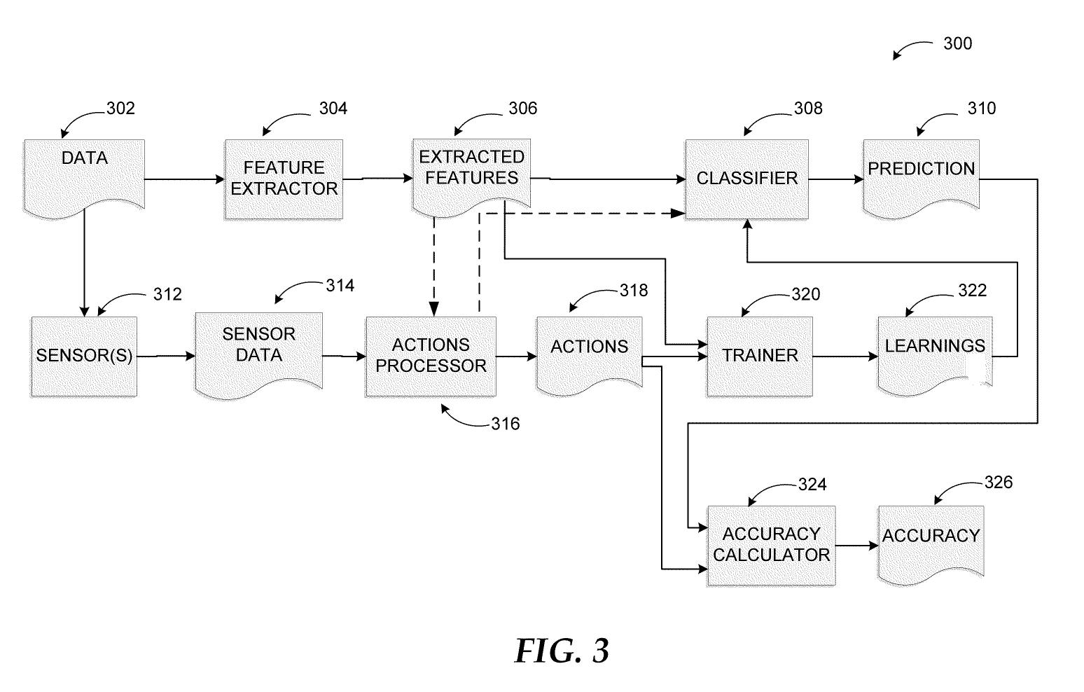

FIG. 3 illustrates an example functional block of dynamically tracking user interactions with incoming data and predicting user response actions, according to embodiments. The prediction system previously discussed in conjunction with FIG. 2 may employ a plurality of components in order to observer user actions in response to incoming data and to predict a user's response action in response to current and future incoming data. As demonstrated in diagram 300, the prediction system may initially facilitate transmitting incoming data 302 from a data source to a receiving user. When the user begins receiving the incoming data 302, a feature extractor 304 may be configured to identify and extract features of the incoming data. Some example extracted features 306 may include the context and/or subject of the data, type of data, sender information, recipient name and/or list, urgency, date and time information, location of the user when the data is received, and number of times the user has replied to the received message.

Additionally, when the user begins receiving the incoming data 302, one or more sensors 312 may be configured to monitor the user's response actions to the incoming data 302. The sensor information 314 including the user's response actions gathered by the sensor 312 may be provided to an actions processor 316 which may produce a list of past response actions 318 taken on the incoming data 302 by the user. The list produced by the actions processor 316 may include all of the actions the user has taken during past observations when the data contained specific extracted features 306. During a training period, which may be a period of time or a set quantity of data points, determined by the prediction system, the actions processor 316 may provide the list of all response actions 318 taken by the user to a trainer 320 component. The trainer component may analyze the list of past user response actions 318 and extracted features 306 identified from observation of the user during the training period in order to identify a pattern of user action in response to incoming data having particular features.

In an example embodiment, the prediction system may determine that the trainer 320 has collected enough data to enable the system to predict future use action in response to incoming data. The trainer 320 may provide its learnings 322 including the identified pattern of user action in response to incoming data having particular features to a classifier 308. The classifier 308 may be configured to interact with the actions processor 316 in conjunction with the learnings 322 from the trainer 320 to analyze the list of past user actions taken in response to data having certain features and predict the user's response to current incoming data. The classifier 308 may identify current incoming data from a data source and extract the features present in the current incoming data. The classifier 212 may access the list of user actions taken in response to past incoming data containing certain features, and the classifier 308 may make a prediction 310 of the user's response based upon the current identified features and the learnings 322 from the trainer 320 regarding the pattern of past user actions.

Moreover, the prediction system may continuously monitor the performance and accuracy of the classifier's predictions through an accuracy calculator 324. The accuracy calculator 324 may compare the classifier's 308 predictions 310 with observations of past user action in response to incoming data having a particular set of features and measure the accuracy 326 of the prediction. The accuracy 326 determination may be used by the trainer 320 to adjust the list of user response actions order to generate more accurate predictions on future user actions. Further, the prediction system may determine an appropriate statistical model to use in order to make the predictions of user action based upon the context of the incoming data 302. For example, a pre-generated statistical model may be provided based on certain variables such as the context of the incoming data and the recipient user of the data in order to determine a statistically based probability and prediction of user action based on the list of observed past user actions.

The example systems in FIG. 1 through 3 have been described with specific configurations, applications, and interactions. Embodiments are not limited to systems according to these examples. A system for tracking and predicting user actions in response to receipt of incoming data may be implemented in configurations employing fewer or additional components and performing other tasks. Furthermore, specific protocols and/or interfaces may be implemented in a similar manner using the principles described herein.

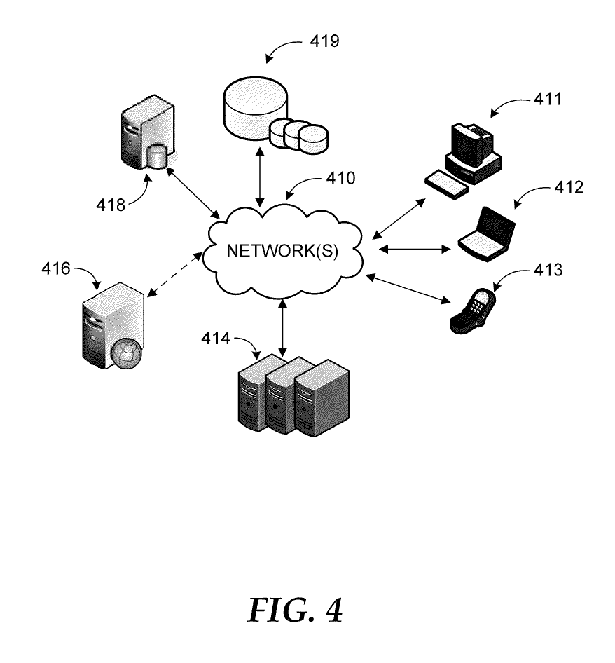

FIG. 4 is an example networked environment, where embodiments may be implemented. A system for tracking and predicting user actions in response to receipt of incoming data may be implemented via software executed over one or more servers 414 such as a hosted service. The platform may communicate with client applications on individual computing devices such as a smart phone 413, a laptop computer 412, or desktop computer 411 ('client devices') through network(s) 410.

Client applications executed on any of the client devices 411-413 may facilitate communications via application(s) executed by servers 414, or on individual server 416. An application executed on one of the servers may facilitate automatically tracking and predicting user actions in response to receipt of incoming data. The application may retrieve relevant data from data store(s) 419 directly or through database server 418, and provide requested services (e.g. document editing) to the user(s) through client devices 411-413.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform for tracking and predicting user actions in response to receipt of incoming data. Furthermore, the networked environments discussed in FIG. 4 are for illustration purposes only. Embodiments are not limited to the example applications, modules, or processes.

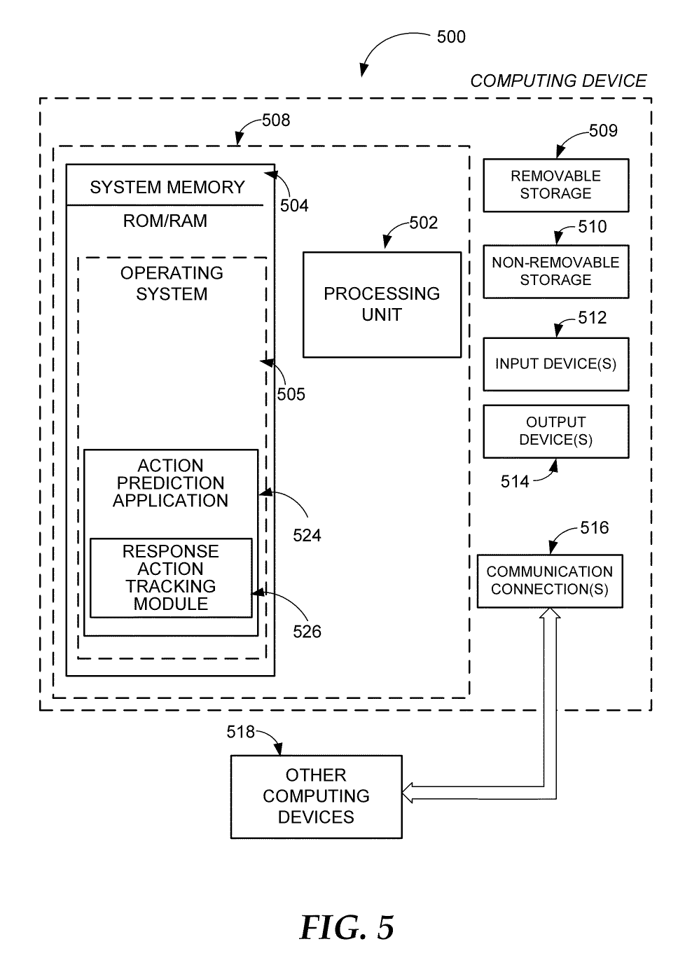

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing an application for tracking and predicting user actions in response to receipt of incoming data according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as an action prediction application 524 and a response action tracking module 526.

The action prediction application 524 may facilitate automatically tracking and predicting user actions in response to receipt of incoming data. The action prediction application 524 may enable a computing device 500 to continually monitor incoming data transmitted over a cloud based environment and received by a user on the user's individual computing device. Through the response action tracking module 526, the action prediction application 524 may observe the user's actions in response to the incoming data, and may generate a pattern of user response actions to incoming data containing a particular set of features. Based upon the generated pattern of user response actions, the action prediction application may predict the user's likely response to a current set of incoming data, and may automatically execute the predicted action on the user's computing device. The action prediction application 524 and the response action tracking module 526 may be separate applications or integrated modules of a hosted service. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

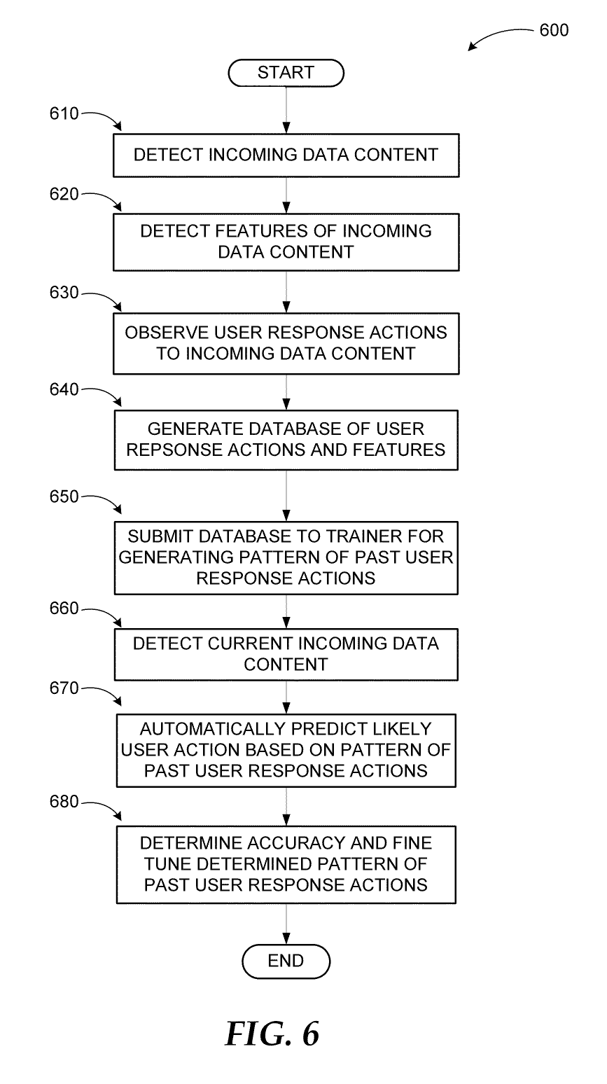

FIG. 6 illustrates a logic flow diagram for a process of tracking and predicting user actions in response to receipt of incoming data, according to embodiments. Process 600 may be implemented on a computing device or similar electronic device capable of executing instructions through a processor.

Process 600 begins with operation 610, where the system may detect incoming data over a cloud-based environment. The incoming data may include email messages, text messages, instant messages, voicemail messages, phone calls, multimedia and/or audiovisual messages, documents, and other similar alerts and data. At operation 620 the system may detect the features of incoming data and extract the features in order to facilitate pattern recognition. The system may employ a feature extractor to identify and extract features of the incoming data. Features of the incoming data may include, for example, the subject of the data, recipient name and/or list, urgency, date and time information, location of the user when the data is received, and number of times the user has replied to the received message.

Operation 620 may be followed by operation 630 where the system may observe the user's response actions to the incoming data. The system may employ one or more sensors for monitoring the user's response actions and reporting the observed actions to the system. The sensor may provide the data to the prediction system, where at operation 640, the system may generate a database of user response actions and features. An actions processor may be configured to organize the extracted features data and the user response action data into a database, which may include a detailed list of the past user response actions taken in response to incoming data containing particular sets of features.

At operation 650, the actions processor may submit the database to a trainer component for generating a pattern of past user response actions. During a training period, the trainer may continuously gather the data from the database of the action processor and synthesize the data to determine an accurate pattern of response actions the user takes.

Operation 650 may be followed by operation 660, where the system may determine that enough data has been collected and synthesized during the designated training period to enable the system to accurately predict a user response action, and the system may detect new current incoming data. At operation 670, the system automatically predict likely user action based on the pattern of past user response actions. The system may employ a classifier to interact with the actions processor in conjunction with the determined pattern of user behavior from the trainer to predict the user's response to current incoming data based upon the current identified features and the learnings from the trainer regarding the pattern of past user actions.

At operation 680, the system may determine the accuracy of the prediction and fine tune the determined pattern of past user response actions. Through an accuracy calculator, the system may compare the classifier's predictions with observations of past user action in response to incoming data having a particular set of features and measure the accuracy of the prediction. The trainer may adjust the list of user response actions order to generate more accurate predictions on future user actions based on the accuracy determination.

The operations included in process 600 are for illustration purposes. Tracking and predicting user actions in response to receipt of incoming data may be implemented by similar processes with fewer or additional steps, as well as in different order of operations using the principles described herein.

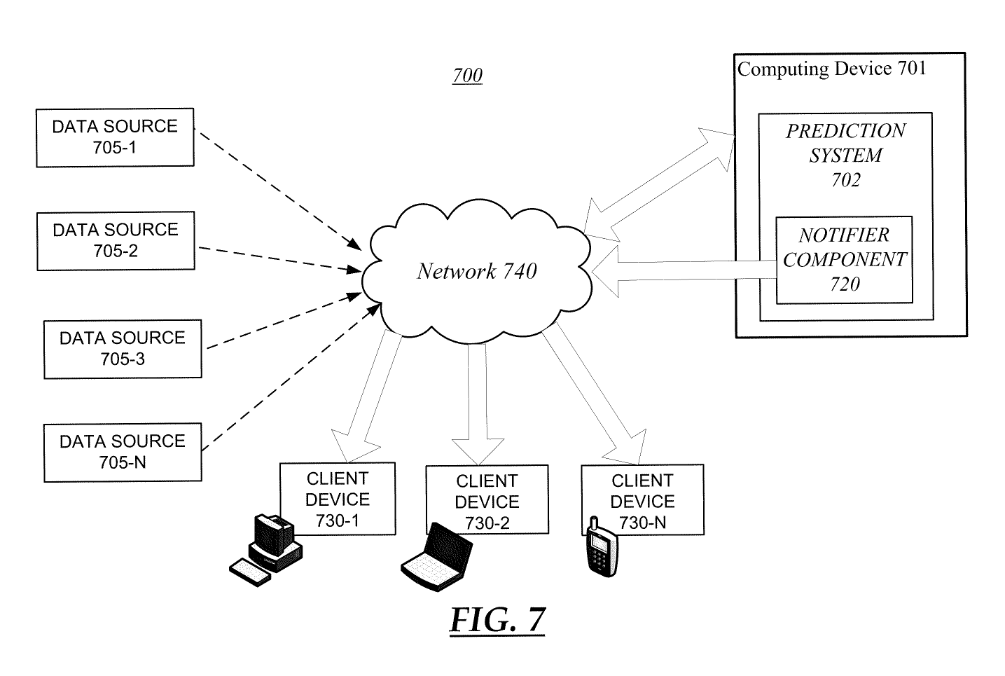

FIG. 7 illustrates an exemplary system for observing and predicting user actions utilized on a client device 701 that includes a notifier component 720. Generally, the prediction program predicts a user's response or action to incoming data from data sources 705-1 . . . 705-4 and may automatically execute the predicted action as described above with reference to FIGS. 1-6. In this additional embodiment, the notifier component 720 receives the predicted action response from prediction program 702 and determines a corresponding user notification to be sent to a computing device 701 and/or client devices 730-1 . . . 730-N via communications network 740 associated with a particular user. The user notification may be a visual, tactile, auditory and/or other user experience as will be described in more detail below.

The system shown in FIG. 7 includes a computing device 701 which may be server 112 within cloud-based network 110 shown in FIG. 1. Alternatively, computing device 701 may be a client specific device such as, for example, a personal computer on which the prediction system 702 is installed. The prediction system 702 is configured to predict a user's response to incoming data received from data sources 705-1 . . . 705-N to an application program based on a pattern of user actions. The prediction system 702 is the prediction system 114 shown and described with reference to FIGS. 1-6, with the addition of notifier component 720. The notifier component 720 receives a directive from the prediction system 702 (e.g. classifier 212 shown in FIG. 2) based on a predicted action response associated with the data received from data source 705-1 . . . 705-N for a particular application program running on computing device 701. The notifier component 720 assigns a user notification to the predicted action response and sends this user notification to one or more client devices 730-1 . . . 730-N via network 740. The client devices 730-1 . . . 730-N may include, for example, a mobile phone, laptop, desktop, tablet computing device, TV, home automation system or applicance, car, heads-up display, music player, game console, security system, video monitor or display, etc. If computing device 701 is a personal computer on which the prediction system 702 is installed, a user notification may be processed by a logic device (e.g. processing unit 502 shown in FIG. 5) within the computing device 701 and the user notification may be sent to a display device (e.g. device 514 shown in FIG. 5). This user notification generates a user experience at the one or more client devices 730-1 . . . 730-N and/or computing device 701. Examples of application programs that may be used on computing device 701 that receive incoming data from data sources 705-1 . . . 705-N may include client-based application programs (or “client applications”) such as, without limitation, MICROSOFT® WORD, MICROSOFT EXCEL®, MICROSOFT POWERPOINT®, MICROSOFT OUTLOOK®, MICROSOFT ACCESS®, MICROSOFT INFOPATH®, MICROSOFT ONENOTE®, MICROSOFT PROJECT, MICROSOFT PUBLISHER, MICROSOFT SHAREPOINT® WORKSPACE, MICROSOFT VISIO®, MICROSOFT OFFICE INTERCONNECT, MICROSOFT OFFICE PICTURE MANAGER, MICROSOFT SHAREPOINT DESIGNER, MICROSOFT LYNC.

Alternatively, prediction system 702 may be installed on a server (e.g. server 112) and may be accessed by a computing device 701 via network 740. Examples of application programs installed on a server that receive incoming data from data sources 705-1 . . . 705-N may include server-based application programs (or “cloud applications”) such as, without limitation, MICROSOFT WINDOWS LIVE®, MICROSOFT OFFICE WEB APPLICATIONS, MICROSOFT OFFICE LIVE, MICROSOFT LIVE MEETING, MICROSOFT OFFICE PRODUCT WEB SITE, MICROSOFT UPDATE SERVER, and MICROSOFT OFFICE 365.

In addition, computing device 701 may also include, without limitation, a, mobile device, a personal digital assistant, a mobile computing device, a smart phone, a computer, a desktop computer, a laptop computer, a notebook computer, a handheld computer, a tablet computer, a work station, a mini-computer, a distributed computing system, a multiprocessor system, a gaming device, consumer electronics, a television, a digital television, and/or combinations of the foregoing. Computing device 701 is illustrated as including prediction system 702 having notifier component 720, however it should be understood that this is done for ease of explanation and computing device 701 may include more or less elements in alternate topologies depending on the type of computing device employed. It is also worthy to note that although the notifier component 720 is shown as an integrated part of the prediction system 702, the notifier component 720 may be implemented as a stand-alone software program separate from prediction system 702 and/or may be implemented as part of another program separate from the prediction system 702 such as part of a cloud based system accessed by prediction system 702 via network 740.

In an exemplary scenario, a user of computing device 701 may receive different types of data from multiple data sources 705-1 . . . 705-N including email messages, text messages, instant messages, voicemail messages, phone calls, multimedia and/or audiovisual messages, documents, RSS feeds, social network updates, and other similar alerts and data. The user of the computing device 701 may receive the incoming data from the data sources 705-1 . . . 705-N via network 740 and may respond to the incoming data by executing a particular action. For example, in response to receipt of an email message, the user may read and respond to the email, ignore, prioritize the email, delete the email, flag the email, move the email to a particular categorized folder, and/or save the email for later review as described in more detail with reference to FIGS. 1-6. The prediction system 702 observes or monitors the actions a user of computing device 701 takes in response to the received incoming data from the one or more data sources 705-1 . . . 705-N. The prediction system 702 suggests the predicted action response to a user of computing device 701 and may await user approval of the predicted action response or may automatically perform the predicted action response on behalf of the user. For example, the prediction system 702 may automatically determine that a predicted action response for an email message marked as “urgent” is to generate a text message to notify the user of the urgent communication. This predicted action response is sent to notifier component 720 where a user experience, such as receiving a text message from notifier component 720 corresponding to the predicted action response to a client device 730-1 . . . 730-N (e.g. cell phone) associated with the user that was the recipient of the email message, is generated. This would be considered an example of a visual user experience in connection with a user notification for the predicted action response for an urgent email message for a particular user. In addition, the user experience associated with the user notification from notifier component 720 may also include initiating a vibrating alarm on the client device to ensure the user notices the urgent communication. This would be considered an example of a tactile user experience in connection with a user notification for the same predicted action response associated with the text message. Moreover, the user experience associated with the user notification may also include sounding an alarm on the client device to ensure the user notices the urgent communication. This would be considered an example of an auditory user experience in connection with a user notification for the same predicted action response associated with the received text message. The above examples illustrate the ability of prediction system 702 to convert incoming data from data sources 705-1 . . . 705-N and generate a user notification in response thereto across a variety of interface modalities.

As another example, the prediction system 702 may receive a communication from a data source 705-1 . . . 705-N via network 740 that a user's home alarm system generated an alarm notification. The prediction system 702 generates a predicted action response of, for example, sending an email message to the user's laptop computer which may be one of the client devices 730-1 . . . 730-N. This predicted action response is sent to notifier component 720 which generates and sends an email message to the user's laptop computer via network 740. In this manner, the predicted action responses generated by prediction system 702 are the basis for determining if a user notification is to be generated based on the incoming data, what type of user experience is assigned to the predicted action response, and to which client device the user notification will be sent.

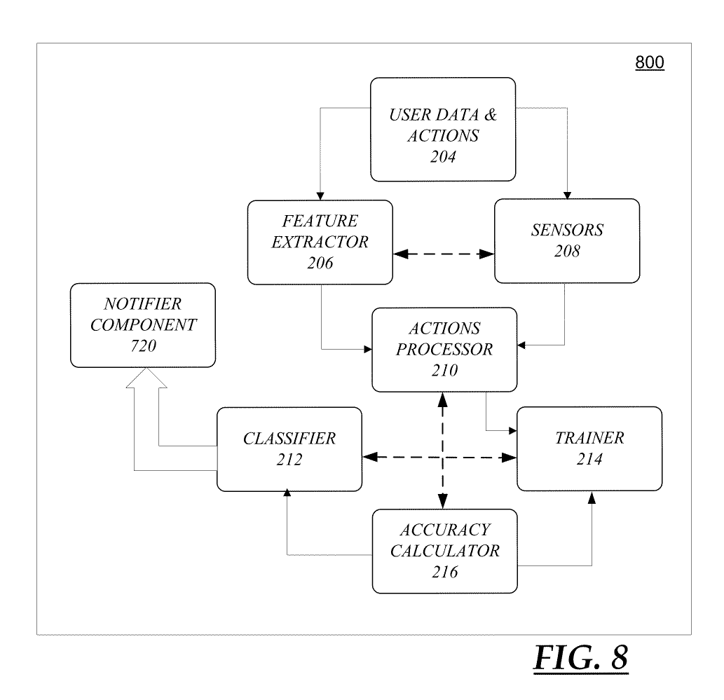

FIG. 8 illustrates a block diagram of a prediction system 800 for dynamically tracking user interactions to incoming data and predicting user response actions consistent with the system described with reference to FIG. 2 with the addition of notifier component 720. As described above, the prediction system 800 employs a classifier 212 to make predictions about the user's actions in response to received incoming data based on the pattern of user response action identified by trainer 214. Again as described above, the classifier 212 may determine a probability that the user may take a particular action in response to incoming data having a particular set of features. Based on the determined probability, the classifier 212 may predict the user's response to the current incoming data, suggest the predicted action response to the user and/or may automatically execute the predicted action. The classifier 212 sends the predicted action response to notifier component 720. Notifier component may be part of prediction system 800, may be implemented as a stand-alone software program separate from prediction system 800 and/or may be implemented as part of another program separate from the prediction system 800 such as part of a cloud based system accessed by prediction system 800.

Notifier component 720 receives the predicted action response from classifier 212 and assigns a user notification to the predicted action response. This assigned user notification may be associated with one or more predicted action responses. By way of example, if the data source is an email message, the predicted action response may include, but not be limited to, categorizing the message, moving the message to a particular file folder, replying to the message promptly, deleting the message, creating a meeting appointment, creating a task etc., as well as combinations of the foregoing. In addition, the predicted action response may also be time sensitive. In particular, if the predicted action response is that a user processes the received message during a particular time of day (e.g. first thing in the morning, after work hours, etc.), then the predicted user response will be provided to the user based on the associated temporal parameter.

The predicted action responses generated by classifier 212 and sent to notifier component 720 may have a varying degree of granularity. For example, a predicted action response from classifier 212 associated received data may range from moving the data to a particular folder to reading and responding to the received data within one hour of receipt thereof. Notifier component 720 generates a corresponding user notification for the particular prediction action response. The user action response may be to move the data to a particular folder from a general mailbox folder and categorize the data within a group of similar data elements. The user experience associated with this user notification may be visual and may consist of providing a group label associated with the similarly categorized items. As another example, a predicted action response generated by classifier 212 upon receipt of an email message may be to generate a calendar appointment. The user notification generated by notifier component 720 may consist of providing a particular icon next to the created calendar appointment. Thus, the user notification generated by the notifier component 720 is based on the type of predicted action response received from classifier 212. Although the preceding examples refer to email based messages, the present disclosure may be utilized with various incoming data types associated with a variety of application programs to generate user notifications.

It is important to note that the predicted action response generated by classifier 212 and the corresponding user notification generated by notifier component 720 may be separate and distinct from the corresponding user experience. For example, if the predicted action response generated by classifier 212 for incoming data is that the user reads the incoming data immediately, the user notification generated by notifier component 720 may be to move or recategorize the incoming data in a position that is most obvious to the user (e.g. move to top of list of incoming data). However, the system 800 can detect if the user has not opened or otherwise read the incoming data for an extended period of time. In this case, system 800 and more particularly notifier component 720 may generate a message in a different mode (e.g. text message to a user's phone) to alert the user of the important incoming data that has not been read. In this manner, the user notification is defined as the recategorizing of the incoming data in a position that is most obvious to the user, as well as generating the text message to the user's phone and the user experience is defined as how that recategorized incoming data is presented to the user.

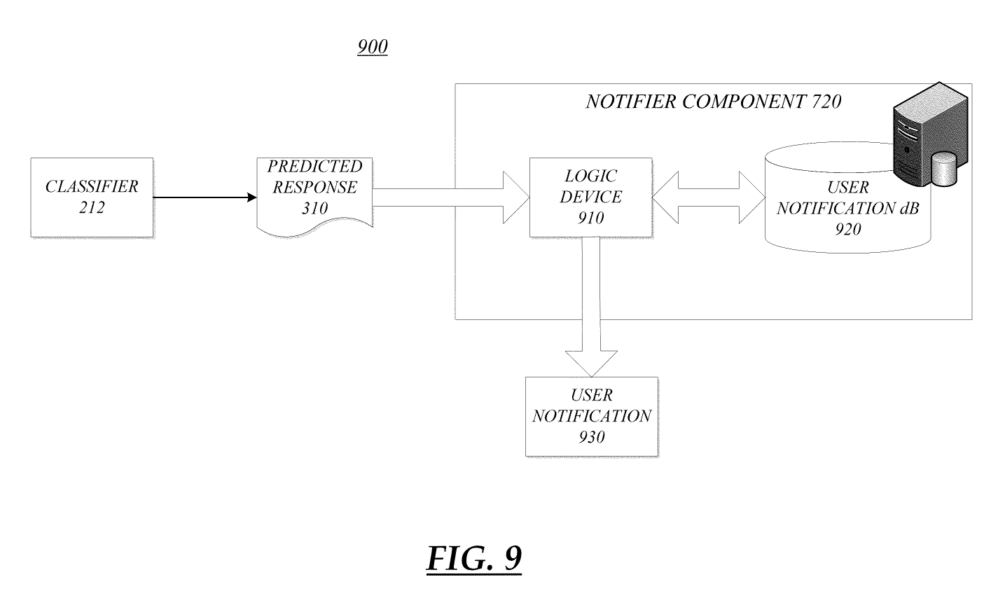

FIG. 9 is a functional block diagram illustrating the processing of a predicted user response action and a corresponding generation of a user notification in response thereto. The prediction system previously discussed in conjunction with FIG. 7 employs a plurality of components in order to observe user actions in response to incoming data and to predict a user's response to current and future incoming data as well as performing the predicted user response. As demonstrated in diagram 900, classifier 212 which may be an integral part of prediction system 702 generates a predicted action response and sends the predicted action response 310 to notifier component 720. Hereinafter, the predicted response may be referred to a predicted action response 310 and shall have the same meaning as the predicted action response referenced with respect to FIGS. 7-8. Notifier component 720 may include a logic device 910 and user notification database 920. The logic device 910 may be the processing unit 502 of computing device 500 shown in FIG. 5 or may be logic circuitry of computing device 701. Various user notifications 930 may be stored in user notification database 920 based on actions previously performed by the user in response to received incoming data and supplied by prediction system 702.

The logic device 910 compares the received predicted action response 310 and retrieves one or more user notifications from notification database 920 that correspond to the predicted action response 310. User notification database may be populated by classifier 212 and may be updated based on the results of accuracy calculator 216. In particular, as system 800 generates predicted responses 310 in connection with incoming data, trainer 215 identifies patterns and trends of how a user responds to this incoming data. The classifier 212 generates predictions about the user's action in response to the incoming data based on the pattern of the user's responses as identified by trainer 214. A user notification 310 is stored in the user notification database 920 corresponding to the predicted response. The user notification may be as simple as highlighting the received incoming data or providing a flag next to an incoming message to indicate that the user should read the message. For example, if prediction system 702 has determined that a user deletes emails received from a particular sender, the predicted action response 310 performed by system 702 is to delete the received email. The user notification 930 that is stored in user notification database for this particular action 310 may be to highlight the deleted items folder within the user's email system once the incoming message is deleted.

Typical user response actions may include deleting, categorizing, flagging, moving, filing, replying, forwarding, searching, creating and sending various messages and tasks. It should be understood that the embodiments described herein are not limited to these user actions. Each of the exemplary predicted action responses 310 may have an associated user notification 930. For example, based on a predicted user action 310, prediction system 702 may determine that a user typically reads and responds to a received email message from a particular sender. As such, a user notification may include a special icon generated next to the received email message on a user interface view. This icon may represent the specific predicted action (e.g. respond to email message) and may also be selectable (e.g. clickable icon) to generate a voice command to the user to remind the user to respond to the email message. In this example, both the generated icon and voice command would be considered part of a user experience 940 associated with the user notification 930.

The notifier component 720 may also generate a user experience in a first mode of communication in response to incoming data received in a different mode. For example, the predicted action response 310 may be based on the receipt by a user of a voicemail message containing the words “emergency” or “urgent.” In this case, the predicted action response 310 may be that a user would immediately listen to this voicemail message. The corresponding user notification stored in database 920 for this predicted action response 310 may be to generate both an email message and a command to one or more separate client devices (e.g. 730-1 . . . 730-N). The corresponding user experience associated with this user notification 930 may be an email message with a unique visual appearance such as, for example, in different color font than standard email messages. In addition, the user notification 930 may also include sending a command to a user's mobile phone triggering the phone to vibrate which informs the user that an email message was sent to the user which the user should read immediately. In this example, both the email message having a unique visual appearance and the vibration of a user's mobile phone would be considered part of the user experience associated with user notification 930 in response to the predicted action response 310. In this manner, the predicted action response 310 is used to determine if a user notification 930 is associated with the predicted response and if so, what type of user notification will be generated that corresponds to the user notification to generate a user experience.

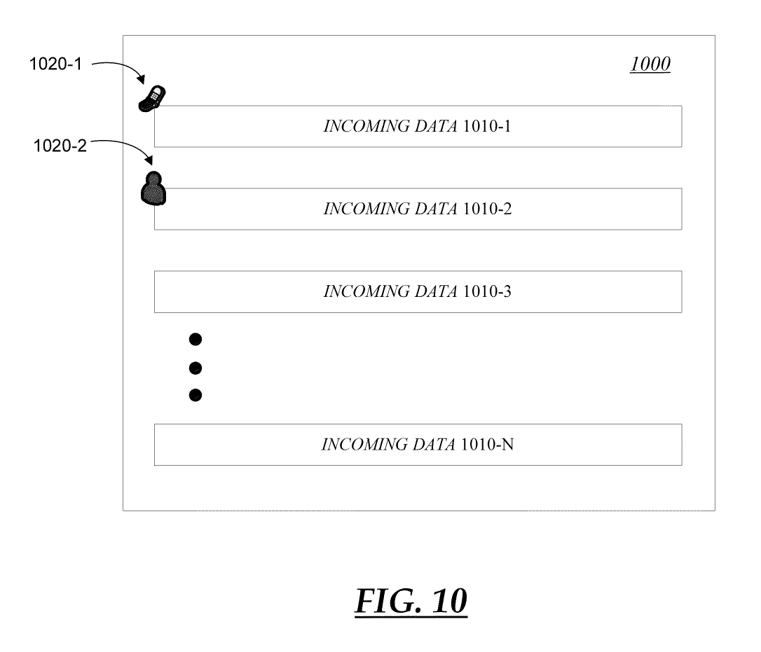

FIG. 10 illustrates an exemplary user experience view 1000 of a user notification 930 to visually illustrate to a user via a client device (e.g. 730-1 . . . 730-N) a user experience of a predicted action response 310 for received incoming data. The user experience view may be part of an application program examples of which have been noted above. In particular, prediction system 800 may generate predicted action response 310 which is provided to notifier component 720. Notifier component 720 compares the received predicted action response 310 with user notifications stored in user notification database 920 corresponding to the predicted response. As mentioned previously, one or more user notifications 930 may be associated with a particular predicted action response 310. The exemplary user interface view 1000 may be produced by processing unit 502 and provided to output device 514 (e.g. display) shown in FIG. 5 when incoming data is received by a user and processed by prediction system 800. The user experience view 1000 includes a plurality of incoming data items 1010-1 . . . 1010-N. These incoming data items may have been listed in order of receipt by the user. However, the incoming data items are received and processed using prediction system 800 resulting in a predicted response 310.

By way of example and for purposes of explanation, an incoming data item 1010-1 may be an email message sent to a user containing information obtained by feature extractor 206 (see FIG. 8) that, based on an identified pattern of past user actions for this type of received incoming date, the user is likely to send a text message to the sender of the incoming data 1010-1. As previously described, a trainer 214 (see FIG. 8) may be configured to continuously gather and analyze received incoming data (e.g. 1010-1 . . . 1010-N) in order to identify patterns and trends in the features of the data and the actions taken by the user. In this example, the analysis of the user's past behavior produces a user notification 930 by notifier component 720 that displays icon 1020-1 proximate the associated incoming data item 1010-1. This icon 1020-1 may indicate to the user that the user's predicted response, based on past behavior learned by prediction system 800, will be to send a text message to the sender of data item 1010-1. In addition, the user notification may also include generating and sending the text message to the sender of the incoming data item 1010-1. In this example, notifier component extracts necessary information from the incoming data item 1010-1 and may search the user's contacts to determine the mobile number for the sender of the incoming data item 1010-1. The notifier component may wait for the user to click the icon 1020-1 to instruct the notifier component to send the generated text message, or it may send the text message automatically in which case the icon 1020-1 is communicates to the user that a text message was sent to the sender. The text message may contain a response by the user consistent with the predicted action response 310.

By way of example and for purposes of explanation, the icon 1020-2 may represent that data item 1010-2 is a social network notification. In particular, an incoming data source may be a social network message configured to provide the user with notification of a message, posting or other social network event. Based on an identified pattern of past user actions for this type of received incoming data item 1010-2, prediction system 800 determines that the user is likely to want to view this social network message in email form promptly. Thus, the predicted action response 310 includes prioritizing this email message within user experience view 1000 associated with the social network message. Notifier component 720 determines that the user notification 930 associated with predicted action response 310 is to assign a particular icon 1020 with this email representing the social network message. In this manner, notifier component 720 generates user notification 930 corresponding to icon 1020-1 to the email message based on the output of logic device 910 comparing the predicted action response 310 with the user notifications stored in user notification database 920. In addition, notifier component 720 may also prioritize the email notification within list of other messages within exemplary user experience view 1000. The icon 1020-2 indicates that the received email represents a social network message. Again, the icon 1020-2 is clickable to provide the user with an explanation of what the icon represents.

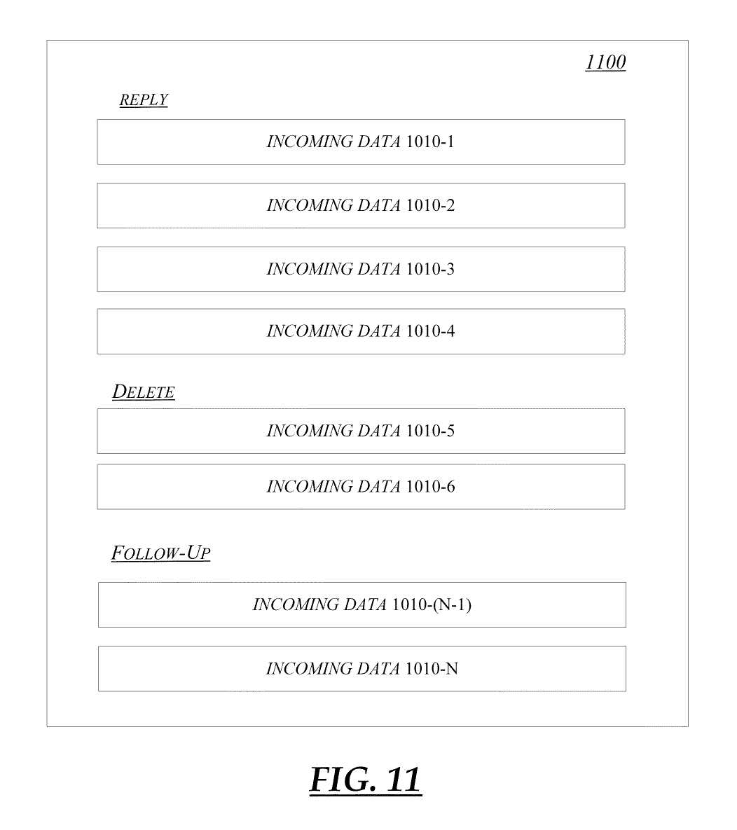

FIG. 11 illustrates another exemplary user experience view 1100 of a user notification 930 to visually illustrate to a user via a client device (e.g. 730-1 . . . 730-N) a predicted action response 310 for receiving incoming data. The exemplary user interface view 1000 may be produced by processing unit 502 and provided to output device 514 (e.g. display) shown in FIG. 5 when incoming data is received by a user and processed by prediction system 800. The user experience view 1000 includes a plurality of incoming data items 1010-1 . . . 1010-N grouped based on predicted action. In prior systems, these incoming data items may have just been listed in order of receipt by the user. However, in accordance with this disclosure the incoming data items are received and processed using prediction system 800 and grouped by predicted action. In particular, prediction system 800 generates a predicted action response 310 for each received data items 1010-1 . . . 1010-N. The predicted action response 310 is sent to notifier component 720 which assigns a user notification 930 to each response 310 based on a list of user notifications stored in user notification database 920. In this manner, each predicted action response 310 has an associated user notification that is illustrated by user interface view 1100. The resulting exemplary user interface view 1100 includes a plurality of incoming data items 1010-1 . . . 1010-4 categorized as items that either have been replied to by system 800 or that need to be replied to by the user. The user interface view 1100 also includes incoming data items 1010-5, 1010-6 categorized as items that have been deleted or that need to be deleted by the user. In addition, user interface view 1100 includes incoming data items 1010-(N−1) and 1010-N categorized as items that require follow-up by the user.

By way of example and for purposes of explanation, the prediction system 800 determined that the user would likely delete incoming data items 1010-5 and 1010-6. Accordingly, prediction system 800 generated the predicted response of deleting these data items and assigned the user notification 930 which categorized these items under the “DELETE” heading on user interface view 1100. This user notification 930 indicates that these data items 1010-5 and 1010-6 have been deleted by prediction system 930 and may remain on user interface view 1100 for a predetermined length of time before which they are moved to a deleted items folder and/or moved to a trash folder. Prediction system 800 also determined that incoming data items 1010-1 . . . 1010-4 would require a reply by the user. This predicted action response 310 corresponding to the reply function generated a user notification 930 for each of the incoming data items 1010-1 . . . 1010-4 by categorizing these incoming data items under the “REPLY” heading on user interface view 1100. As illustrated, the incoming data items 1010-1 . . . 1010-4 that require a reply by the user may be identified first on user interface view 1100. This may be due to the fact that these data items 1010-1 . . . 1010-4 have a temporal requirement in that they have been identified by the user as important based on past practices as learned by trainer 214 within prediction system 702. Thus, these data items 1010-1 . . . 1010-4 require a timely reply and are identified first. Prediction system 800 also determined that incoming data items 1010-(N−1) and 1010-N would require follow-up by the user. This predicted action response 310 corresponding to the follow-up function generates a user notification 930 for each of the incoming data items 1010-(N−1) and 1010-N by categorizing these incoming data items under the “FOLLOW-UP” heading on user interface view 1100.

In this manner, the notifier component 720 of prediction system 800 determines a predicted action response 310 associated with received data items 1010-1 . . . 1010-N and based on the predicted response, assigns one or more user notifications 930 to the predicted response. Thus, user interface view 1100 is exemplary of the user experience that helps users quickly and accurately identify incoming data items and efficiently process or act on those items based on the predicted action response.

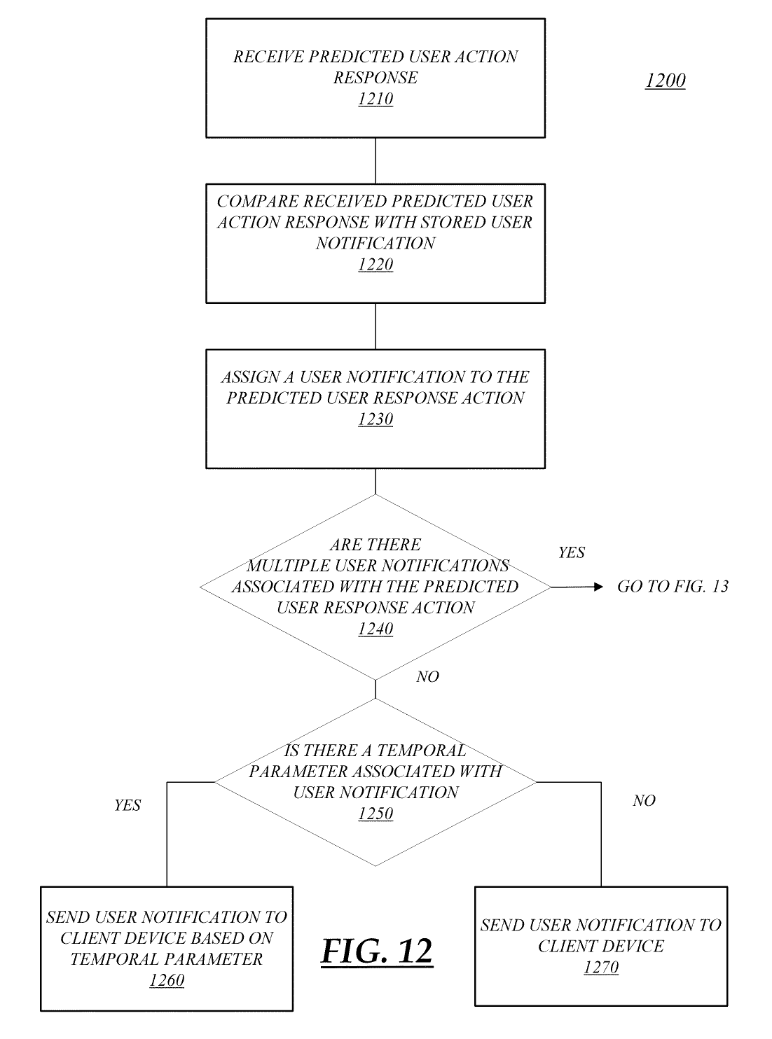

FIG. 12 illustrates one embodiment of a logic flow 1200 for the system of FIG. 7. The logic flow 1200 may be representative of some or all of the operations executed by one or more embodiments described herein, such as notifier component 720, for example.

In the illustrated embodiment shown in FIG. 12, a predicted action response is received at block 1210. For example, a predicted action response 310 is generated by prediction system 702. The predicted action response 310 is generated by utilizing trainer 215 to identify patterns and trends of how a user response to the incoming data. A classifier 212 generates predictions about the user's action in response to the incoming data based on the pattern of the user's responses as identified by trainer 214.

A comparison is made between the predicted action response and the stored user notifications at block 1220. For example, notifier component 720 may include a logic device 910 and user notification database 920. The logic device 910 may be the processing unit 502 of computing device 500 shown in FIG. 5 or may be a logic device of computing device 701. Various user notifications 930 may be stored in user notification database 920 based on actions previously performed by the user in response to received incoming data and supplied by prediction system 702. The logic device 910 compares the received predicted action response 310 with one or more user notifications as retrieved from user notification database 920 that correspond to the predicted action response 310. In particular, user notification database 920 may include a table that identifies each predicted action response 310 and a corresponding one or more user notifications 930 associated with the user predicted action response 310. Each of these user notifications 930 associated with the user predicted action response 310 are assigned to the user notification at block 1230. For example, each user notification 930 retrieved from the user notification database 920 may correspond to a different user experience. For example, if the predicted action response 310 to an incoming data item (e.g. 1010-5) is to delete the incoming data item, the user experience as illustrated on user interface view 1100 may be to categorize the incoming data item under a “DELETE” heading. Alternatively, the user notification for this deleted incoming data item may be to move the deleted incoming data item to a deleted items folder and not categorize the incoming data item under the DELETE heading on user interface view 1100. Thus, depending on the type of user notification 930 assigned to the predicted action response 310 will determine how the prediction system identifies the predicted action response to the user.

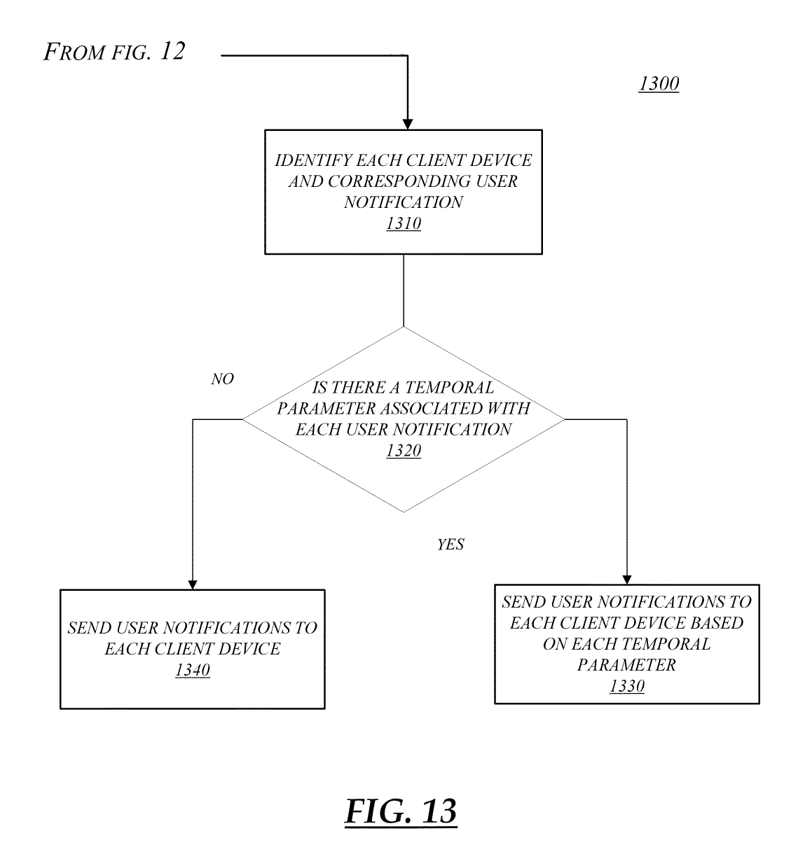

A determination is made at block 1240 whether or not multiple user notifications are associated with a predicted user response action. If the user notification 930 corresponding to a predicted action response 310 consists of providing a user with multiple user notifications in different forms (e.g. categorizing a received email message and sending a text notification) or the same form (e.g. sending text messages at multiple time intervals) then the process proceeds to FIG. 13. If the user notification 930 corresponding to the predicted action response 310 does not consist of providing a user with multiple user notifications then the logic flow proceeds to block 1250. For example, the prediction system 702 may automatically determine that a predicted action response 310 for an email message marked as “urgent” is to generate a text message to notify the user of the urgent communication. This predicted action response 310 is sent to notifier component 720 where a user notification 930, such as sending a text message corresponding to the predicted action response to a client device 730-1 . . . 730-N (e.g. cell phone) associated with the user that was the recipient of the email message, is generated.

A determination is made at block 1250 whether or not a temporal parameter is associated with the user notification. For example, if the predicted action response 310 is that the user typically replies to a particular incoming data item (e.g. incoming data 1010-1) within one hour of receiving it, then the user notification may be to categorize the incoming data item under a “REPLY” heading on user interface view 1100. Alternatively, a user notification 930 associated with a particular data item may include categorizing the data item based on the time of day the data item is received in which case the user notification. This temporal parameter may be generated with the predicted action response 310 by prediction system 702 and/or may be stored in user notification database 920 for each user notification 930.

If a temporal parameter is associated with the user notification, then the user notification is sent to a client device associated with the user based on the temporal parameter at block 1260. For example, a predicted action response 310 for incoming data item 1010-1 may be that the user will respond to the item immediately, but only if the incoming data item 1010-1 is received first thing in the workday morning (e.g. within a predefined time period). In this case, the incoming data item 1010-1 may be categorized under the “REPLY” heading on user interface view 1100 if it is received by the user within a predefined time period, but may be categorized under the “FOLLOW-UP” heading on user interface view 1100 if it is received by the user outside of the predefined time period. In addition, these predetermined time periods may be user defined and may be based on, for example, a user's work hours, commuting time, weekend hours, etc. In this manner, data items (e.g. 1010-1 . . . 1010-N) may be identified in a particular category or grouping according to the time within which the user typically responds to these items. The present disclosure is not limited by this exemplary temporal context.

If a temporal parameter is not associated with the user notification, then a user notification is sent to the client device at block 1270. For example, once the type of user experience is determined with the user notification 930, the user notification is sent to one or more client devices associated with the user without regard for a temporal parameter.

FIG. 13 illustrates one embodiment of a logic flow 1300 for the system of FIG. 7. In particular, the logic flow 1300 is a continuation of block 1240 where a determination was made that multiple user notifications are associated with the predicted action response. For example, an incoming data source may be a social network message configured to provide the user with notification of a message, posting or other social network event. Based on an identified pattern of past user actions for this type of received incoming data item 1010-2 shown in FIG. 10, prediction system 800 determines that the user is likely to want to view this social network message in email form promptly. Thus, the predicted action response 310 includes prioritizing this email message within user experience view 1000 associated with the social network message. Notifier component 720 determines that the user notification 930 associated with predicted action response 310 comprises assigning a particular icon 1020 to this email representing that the email corresponds to a social network message or alert. In addition, notifier component 720 may also prioritize the email within the list of other messages. In this manner, notifier component 720 generates two types of user notifications 930, one corresponding to the assigning of icon 1020-1 to the email message and another to prioritizing the email message representing the social network message or alert within the list of all the messages received by the user.

If multiple user notifications are associated with the predicted user response action, then the logic flow proceeds to block 1310 to identify each client device and the corresponding user notification. For example, if multiple user notifications 930 are associated with a predicted response action 310, logic flow 1300 determines if each of the user notifications 930 go to the same client device (e.g. 730-1) or if one or more of the user notifications go to different client devices (e.g. 730-1 . . . 730-N).

At block 1320, a determination is made whether a temporal parameter is associated with each user notification to control the generation of each of the identified user notifications based the corresponding temporal parameter. Similar to the temporal determination described with reference to FIG. 12 at block 1250, a temporal parameter associated with each user notification may dictate when each of the assigned user notifications 930 is sent to a client device (e.g. 730-1 . . . 730-N). If no temporal parameter is associated with each user notification, then the logic flow proceeds to block 1340 where the multiple user notifications are sent to each client device. If a temporal component is associated with one or more of the user notifications, then the logic flow 1300 proceeds to block 1330 where the user notifications are sent to each client device based on the corresponding temporal parameter.

As described herein, a system is provided for automatically predicting the actions a user is likely to take in response to receipt of incoming data. The system includes a notifier component that generates a particular user notification corresponding to the predicted action response. The notifier component utilizes a logic device to compare the received user predicted action response with a plurality of user notifications stored in a database. The notifier component sends the user notification to one or more user devices associated with a user.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating an action-oriented user experience comprising:
receiving a predicted action response associated with incoming data, the predicted action response based on a pattern of actions associated with the received incoming data;
assigning a user notification to the predicted action response; and
sending the user notification to a user.

2. The method of claim 1 wherein sending the user notification comprises generating an auditory user experience to a device associated with a user.

3. The method of claim 1 wherein sending the user notification comprises generating a tactile user experience to a device associated with a user.

4. The method of claim 1 wherein sending the user notification comprises generating a visual user experience to a device associated with a user.

5. The method of claim 1 wherein the incoming data is received by a first user device and the sending the user notification is sent to a second user device different from the first user device.

6. The method of claim 1 assigning a temporal characteristic to the user notification and sending the user notification to a user based on the temporal characteristic.

7. The method of claim 1 further comprising:
automatically performing the predicted action response; and
sending the user notification after performing the predicted action response.

8. The method of claim 1 wherein the incoming data is in a first form and the user notification is in a second form different from the first form.

9. The method of claim 1 wherein assigning a user notification to the predicted action response further comprising:
comparing the predicted action response with a plurality of user notifications stored in a database; and
selecting at least one of the plurality of user notifications corresponding to the predicted response.

10. The method of claim 1 further comprising:
employing a notifier component for receiving the predicted action response associated with incoming data;
enabling the notifier component to determine the user notification based on the predicted action response; and
enabling the notifier component to send the user notification to the user to generate the user experience based on the user notification.

11. An apparatus comprising:
a logic device operative to receive a predicted action response associated with incoming data, to determine whether a user notification corresponds to the predicted action response and to send a user experience corresponding to the user notification to a user device, the predicted action response based on a pattern of user actions associated with the received incoming data.

12. The apparatus of claim 11 further comprising a memory communicating with the logic device, the memory configured to store a plurality of user notifications corresponding to the predicted action response, the logic device operative to access the memory to determine which of the plurality of user notifications correspond to the predicted action responses.

13. The apparatus of claim 12, wherein the user notification comprising a temporal indicator representing when the user experience corresponding to the user notification is sent by the logic device.

14. The apparatus of claim 11 wherein the user experience is an auditory response.

15. The apparatus of claim 11 wherein the user experience is a tactile response.

16. The apparatus of claim 11 wherein the user experience is a visual response.

17. An article comprising a computer readable storage medium containing instructions that when executed cause a system to:
receive a predicted action response associated with incoming data, the predicted action response based on a pattern of actions associated with the received incoming data;
assign a user notification to the predicted action response; and
send the user notification to a user.

18. The article of claim 17 further comprising instructions that when executed cause a system to compare the received predicted action response with a plurality of user notifications corresponding to the predicted action response.

19. The article of claim 18 further comprising instructions that when executed cause a system to select at least one of the plurality of user notifications corresponding to the received predicted action response.

20. The article of claim 17 further comprising instructions that when executed cause a system to receive the incoming data is a first form and send the user notification to a user in a second form different from the first form.
